(19) United States
(12) Patent Application Publication
(10) Pub. No.: US 2003/0128266 A1
(43) Pub. Date: Jul. 10, 2003

(54) Code printing method and code format

(76) Inventors: Hideki Chujo, Kyoto (JP); Manabu Ohshima, Kyoto (JP)

Correspondence Address: ROSENTHAL & OSHA L.L.P., 1221 MCKINNEY AVENUE, SUITE 2800, HOUSTON, TX, 77010, US

(21) Appl. No.: 10/258,773

(22) PCT Filed: Apr. 26, 2001
(86) PCT No.: PCT/JP01/03670

(51) Int. Cl. B41J 2/01

(52) U.S. Cl. 347/107

(57) ABSTRACT

The present invention relates to a code printing method and a code format, capable of accurate recognition of codes. Printing by nozzles excluding nozzles at one end out of nozzles of a printer head prevents codes printed by the scanning of the printer head from overlapping at each scanning as shown by a portion surrounded by an oval part in the drawing to permit accurate printing of codes. In addition, by printing a synchronizing code column, positions of printed dots can be accurately detected to thereby permit accurate recognition of printed codes.

### BACKGROUND OF THE INVENTION

1. Field of the Invention

The present invention relates to a code printing method and a code format and particularly, the present invention relates to a code printing method and a code format, whereby a code to be image-recognized can be accurately recognized.

2. Description of the Related Art

A technology such that the digital data is coded and printed by using a printer has been generally prevalent.

Upon printing the digital data, by allocating the data of one bit to one nozzle (i.e., one dot) of a printer head, for example, by using an ink jet printer in which nozzles are lined in a row, the coded information is printed at a predetermined position of a print sheet with 1 of the digital data as black (a dot is printed) and 0 as white (no dot is printed).

This printed code is read by an optical reader by the dot. By carrying out the decoding processing such that if the predetermined position is black (a dot is printed), it is decoded as 1 and if the predetermined position is white (no dot is printed), it is decoded as 0, this printed code is recognized as the original digital data.

FIG. 1(A) shows an example such that a code of the digital data is printed by an ink jet printer. In other words, against a print sheet 1, a printer head 2 is scanned (main-scanned) in an arrowhead A direction in the drawing (i.e., a width direction of the print sheet 1) by the nozzle width. In this occasion, at a predetermined scanning position, the ink is discharged toward the print sheet 1 from a certain nozzle 3 and a code as shown in FIG. 1(A) is printed.

As shown in FIG. 1(A), when a single main scanning is terminated, the print sheet 1 is fed in an arrowhead direction B (a longitudinal direction) (i.e., a width scanning direction) by the width of the printer head 2 and the main scanning is carried out at this position, as shown in FIG. 1(B), a code is printed. The repetition of such processing generates a code.

In the case of reproducing the digital data by a reader, accuracy of a position of a dot to be printed by each nozzle 3 of the above described printer head 2 affects the accuracy of code recognition.

As a factor of the affect on the accuracy of the position of the dot to be printed by each nozzle, the accuracy in arranging the nozzle 3 to be formed on the printer head 2, the scanning accuracy of the printer head 2 with respect to the print sheet 1, the accuracy in attaching the ink to be discharged from the nozzle 3 and the accuracy in feeding the print sheet may be considered.

Among the above mentioned factors, particularly, the accuracy in feeding the print sheet easily affects the accuracy of the dot positions. The above mentioned FIG. 1(B) shows an ideal case such that the print sheet 1 is fed to an appropriate position. However, in the actual printing, the misalignment is generated. For example, after one main scanning as shown in FIG. 2(A), if the print sheet 1 has been fed in the arrowhead direction B as shown in FIG. 2(B), the printer head 2 is main-scanned in the arrowhead direction A once again. However, as shown by a portion surrounded by an oval part in FIG. 2(B), if a feeding position of the print sheet 1 is slightly deviated from the original position in a lower direction in the drawing, a code that was printed by a nozzle 3p (assuming that there are sixteen nozzles in the nozzle 3 (i.e., nozzles 3a to 3p) according to an example shown in FIG. 2) at the lowest stage in the drawing at a first main scanning may overlap with a code that is printed by the uppermost stage in the drawing at a second main scanning.

In this way, according to the above described code printing method, there is a problem such that, if the accuracy in feeding the print sheet is lower, the codes are printed as overlapping with each other, so that the accuracy of code recognition has been lowered upon reading the code (recognizing the digital data).

### BRIEF SUMMARY OF THE INVENTION

The present invention has been made taking the foregoing problems into consideration, an object of the present invention is to provide a code printing method and a code format, thereby a code to be printed can be accurately recognized.

A first code printing method according to the present invention to attain the above described object is characterized by comprising the steps of scanning the printer head and printing a code on a print sheet by a predetermined nozzle among the plural nozzles at a predetermined scanning position in the printer head that was scanned according to the processing of the scanning step, wherein, according to the processing in the printing step, a predetermined nozzle is only used for printing except for the nozzle at one end of the printer head or at least not less than one nozzle at the opposite ends of the printer head among the plural nozzles.

According to the first code printing method according to the present invention, the printer head is scanned and a code is printed on a print sheet by a predetermined nozzle among the plural nozzles at a predetermined scanning position in the printer head that was scanned, wherein a predetermined nozzle is only used for printing except for the nozzle at one end of the printer head or at least not less than one nozzle at the opposite ends of the printer head among the plural nozzles. Hereby, it is possible to restrain the generation of overlap of the codes to thereby allow the accurate recognition of the printed codes.

The processing of the scanning step according to the present invention means, for example, the processing shown in FIG. 4 such that the printer head 2 is scanned in the arrowhead direction A.

The processing of the printing step according to the present invention means, for example, the processing as shown in FIG. 4 such that, when the printer head 2 is scanned in the arrowhead direction A by the processing of the scanning step and the printer head 2 passes through a predetermined scanning position, the ink is discharged toward the print sheet 1 from the certain nozzle 3 and thereby, the dots are printed.

The description that according to the processing in the printing step, a predetermined nozzle is only used for printing except for the nozzle at one end of the printer head 2 or at least not less than one nozzle at the opposite ends of the printer head 2 among the plural nozzles means that nozzles 3aand 3b at one end of the printer head 2 are not used but other nozzles, namely, nozzles 3c to 3p are used, for example as shown in FIG. 4.

A second code printing method according to the present invention to attain the above described object is characterized by comprising the steps of scanning the printer head and printing a code on a print sheet by a predetermined nozzle among the plural nozzles at a predetermined scanning position in the printer head that was scanned according to the processing of the scanning step, wherein, according to the processing in the printing step, a predetermined nozzle among the plural nozzles is only used for printing codes except for at least not less than one nozzle at the opposite ends of the printer head and the nozzle at one end of the printer head among the plural nozzles is used for printing a mark showing a scan switching position in the scanning step.

In the second code printing method according to the present invention, the printer head is scanned and a code is printed on a print sheet by a predetermined nozzle among the plural nozzles at a predetermined scanning position in the printer head that was scanned, wherein a predetermined nozzle among the plural nozzles is only used for printing codes except for at least not less than one nozzle at the opposite ends of the printer head and the nozzle at one end of the printer head among the plural nozzles is used for printing a mark showing a scan switching position in the scanning step. Hereby, it is possible to restrain the generation of overlap of the codes to thereby allow the accurate recognition of the printed codes.

The description that, according to the processing in the printing step, a predetermined nozzle among the plural nozzles is only used for printing codes except for at least not less than one nozzle at the opposite ends of the printer head and the nozzle at one end of the printer head among the plural nozzles is used for printing a mark showing a scan switching position in the scanning step means, for example, to print the codes at a scan switching position mark 41 shown in FIG. 12(A).

A third code printing method according to the present invention to attain the above described object is characterized by comprising the steps of scanning the printer head and printing a code on a print sheet by a predetermined nozzle among the plural nozzles at a predetermined scanning position in the printer head that was scanned according to the processing of the scanning step; wherein, according to the processing in the printing step, synchronizing codes are printed at a first column and a last column of the code or a first row and a last row of the code according to the processing in the scanning step.

According to the third code printing method according to the present invention, the printer head is scanned and a code is printed on a print sheet by a predetermined nozzle among the plural nozzles at a predetermined scanning position in the printer head that was scanned, wherein synchronizing codes are printed at a first column and a last column of the code or a first row and a last row of the code. Hereby, it is possible to allow the accurate recognition of the printed codes.

The description that, according to the processing in the printing step, synchronizing codes are printed at a first column and a last column of the code or a first row and a last row of the code according to the processing in the scanning step means, for example, to print a synchronizing code column 11 shown in FIG. 4.

A first code format according to the present invention to attain the above described object is characterized by comprising a mark showing a scan switching position for each range to be printed by single scanning of the printer head.

The first code format according to the present invention includes a mark showing a scan switching position for each range to be printed by single scanning of the printer head. Hereby, it is possible to allow the accurate recognition of the printed codes on the basis of the scan switching position.

A mark for showing the scan switching position according to the present invention means, for example, the scan switching position mark 41 shown in FIG. 12(A).

A second code format according to the present invention to attain the above described object is characterized by including a header portion having the information with respect to any one of the number of the nozzles of the printer head and a scanning direction of the printer head or the information with respect to both of them.

The second code format according to the present invention includes a header portion having the information with respect to any one of the number of the nozzles of the printer head and a scanning direction of the printer head or the information with respect to both of them. Hereby, it is possible to accurately detect the positions of the codes on the basis of the information of the header portion to thereby allow the accurate recognition of the printed codes.

The header portion according to the present invention means, for example, a header portion 51 shown in FIG. 14, namely, a portion that is arranged at a head of a code to be printed including the information with respect to any one of the number of the nozzles 3 and a scanning direction of the printer head 2 or the information with respect to both of them.

A third code format according to the present invention to attain the above described object is characterized by including a synchronizing code in a vertical direction or a parallel direction against a feeding direction of a print sheet for each range to be printed by single scanning of the printer head.

The third code format according to the present invention includes a synchronizing code in a vertical direction or a parallel direction against a feeding direction of a print sheet for each range to be printed by single scanning of the printer head. Hereby, it is possible to accurately detect the positions of the codes on the basis of the synchronization code to thereby allow the accurate recognition of the printed codes.

According to the above described first code printing method, it is possible to print one of the above mentioned synchronization code and the above mentioned header portion or both of them.

### BRIEF DESCRIPTION OF THE DRAWINGS

FIG. 1 is a view for explaining a conventional code printing method;

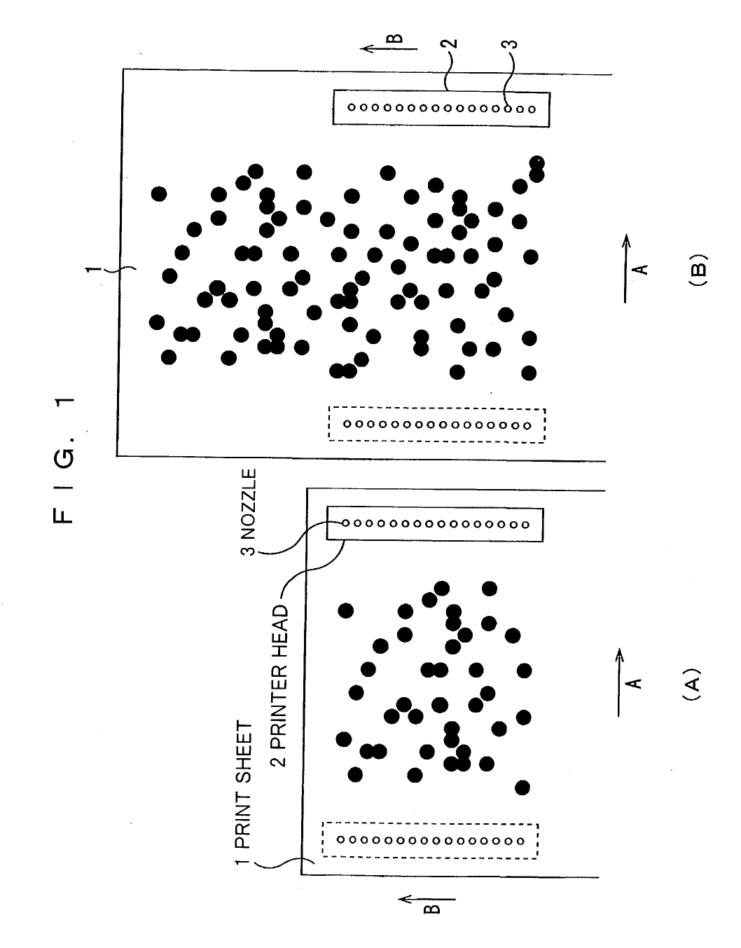

FIG. 2 is other view for explaining a conventional code printing method;

FIG. 3 is a view for explaining a code printing method, to which the present invention is applied;

FIG. 4 is other view for explaining a code printing method, to which the present invention is applied;

FIG. 5 is other view for explaining a code printing method, to which the present invention is applied;

FIG. 6 is a block diagram for explaining a constitution of a reader;

FIG. 7 is a view for explaining the processing, whereby codes are read by the reader;

FIG. 8 is a flow chart for explaining the processing, whereby codes are read by the reader;

FIG. 9 is other view for explaining the processing, whereby codes are read by the reader;

FIG. 10 is other view for explaining a code printing method, to which the present invention is applied;

FIG. 11 is a flow chart for explaining other processing, whereby codes are read by the reader;

FIG. 12 is other view for explaining a code printing method, to which the present invention is applied;

FIG. 13 is a flow chart for explaining other processing, whereby codes are read by the reader;

FIG. 14 is a view for explaining a header portion in the codes;

FIG. 15 a flow chart for explaining the processing, whereby codes that is provided with the header portion are read; and

FIG. 16 is a view for explaining an example such that the codes are printed in a longitudinal direction of the print sheet.

### DETAILED DESCRIPTION OF THE INVENTION

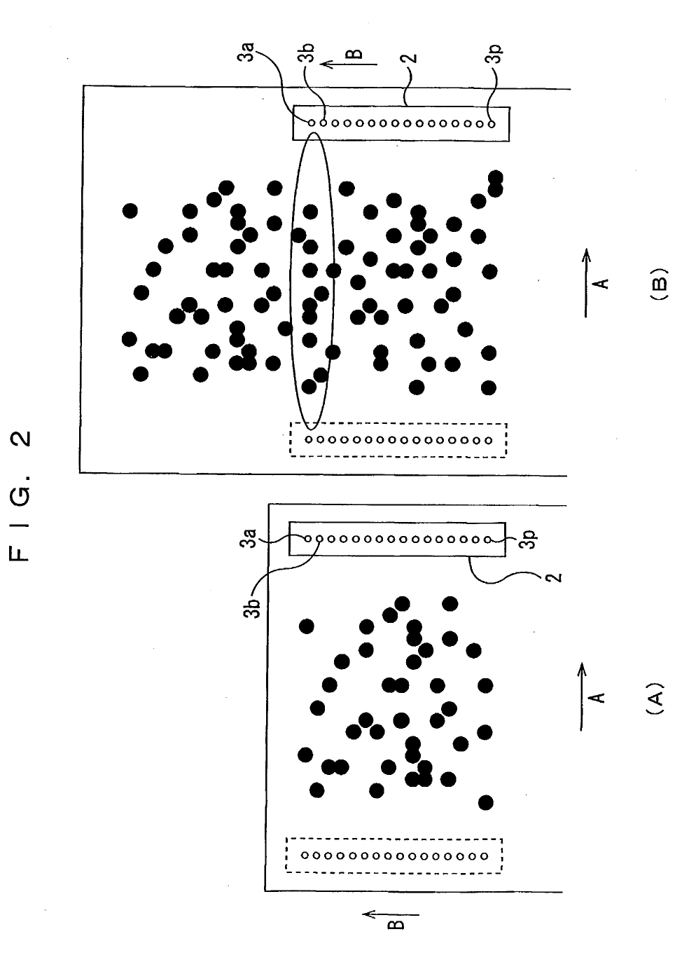

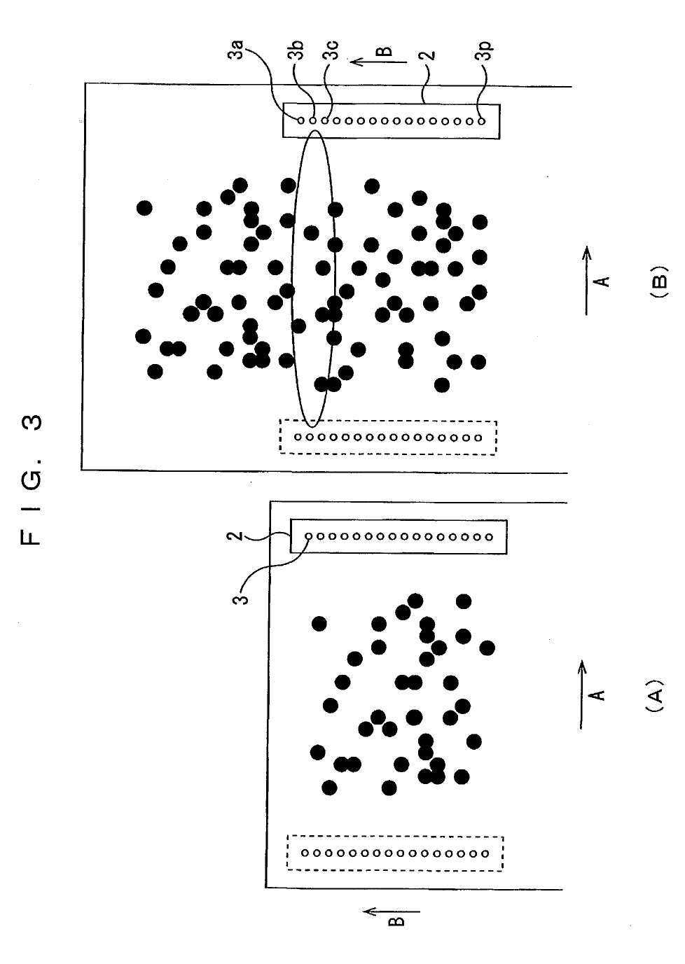

FIG. 3 shows an example of the codes that are printed by a code printing method (a code format), to which the present invention is applied. With respect to the parts corresponding to a code constitution shown in FIG. 2, the identical reference numerals are given and the explanation thereof is omitted.

As shown in FIG. 3(A), these codes are printed without using the nozzles 3a and 3b (in the drawing, two nozzles at the uppermost end) of the printer head 2. Hereby, printing in the first main scanning of the printer head 2 is finished and the print sheet 1 is fed (namely, sub scanning) in the arrowhead direction B as shown in FIG. 3(B). After that, even if the printing is carried out by the second main scanning, as shown by a portion surrounded by an oval part in FIG. 3(B), the codes are not printed by the nozzles 3a and 3b at the second main scanning in a portion in which the codes are printed by the nozzle 3p (in the drawing, the nozzle at the lowest end) at the first main scanning, thereby, overlapping of the codes as shown in FIG. 2(B) is prevented even when the print sheet 1 is not fed to the appropriate position (namely, when the position of the sub scanning is deviated).

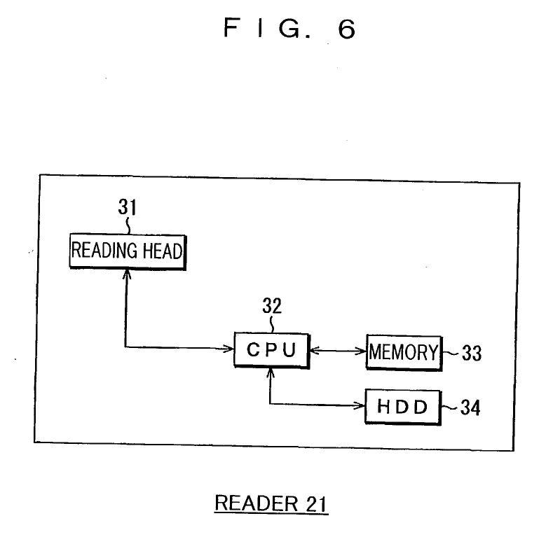

However, according to the method shown in FIG. 3, as shown by a portion surrounded by an oval part in FIG. 3(B), spaces are left in the codes at a border between a printing area of the former main scanning and that of a next main scanning. Thus, it is feared that the printed codes are not capable of being accurately recognized when the codes are read by a reader 21 (FIG. 6).

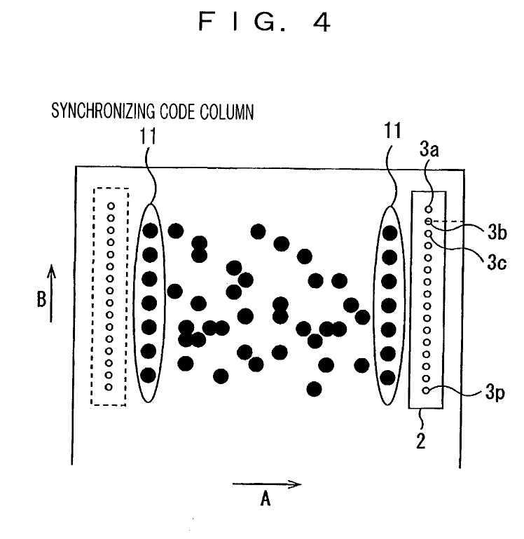

Therefore, as shown in FIG. 4, the synchronizing code column 11 is printed at a first column and the last column in a main scanning direction (i.e., a moving direction of the printer head 2 to be shown by the arrowhead direction A) in the codes to be printed by the printer head 2, thereby, the positions of the code to be read can be accurately detected. The synchronizing code column 11 comprises dots that are printed at regular intervals by each nozzle 3 of the printer head 2. Upon reading a code, it is possible to recognize a position of the printed codes on the basis of this synchronizing code column 11 as a reference position. In this case, a column means a series of dots in a direction in parallel with the printer head 2 (i.e., a direction vertical with respect to the main scanning direction). On the contrary, a row means a series of dots in a direction in parallel with the main scanning direction of the printer head 2.

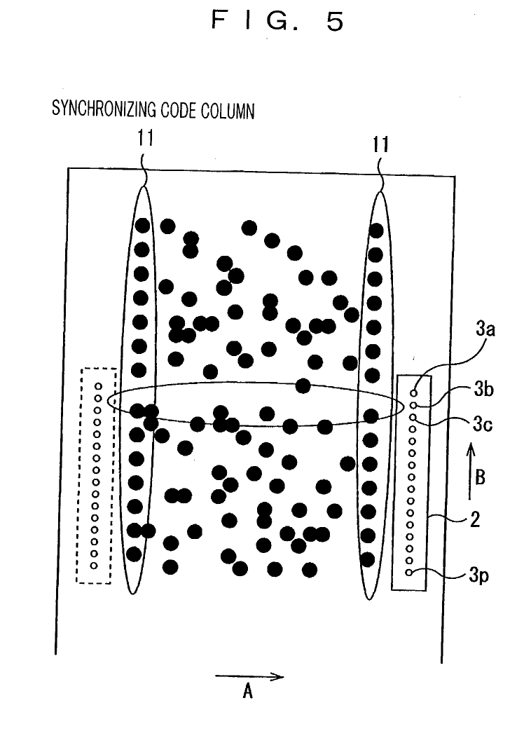

Accordingly, even if spaces as shown by a portion surrounded by an oval part in FIG. 5 are left by printing the codes without using the nozzles 3a and 3b, it is possible to recognize the codes accurately since the reader 21 (FIG. 6) is capable of recognizing the positions of the printed codes with reference to the synchronizing code column 11 to thereby allow accurate recognition of the printed codes. Each synchronizing code (i.e., each dot) of the synchronizing code column 11 is printed at regular intervals, namely, for each one row or two rows in a sub scanning direction (i.e., the feeding direction of the print sheet 1 shown by the arrowhead direction B in FIG. 4) and with reference to the position of the recognized synchronizing code, it is possible to detect a position of each dot that is printed as a code. Alternatively, in the following explanation, it is assumed that the synchronizing code column 11 is printed for each one row, however, other interval may be available.

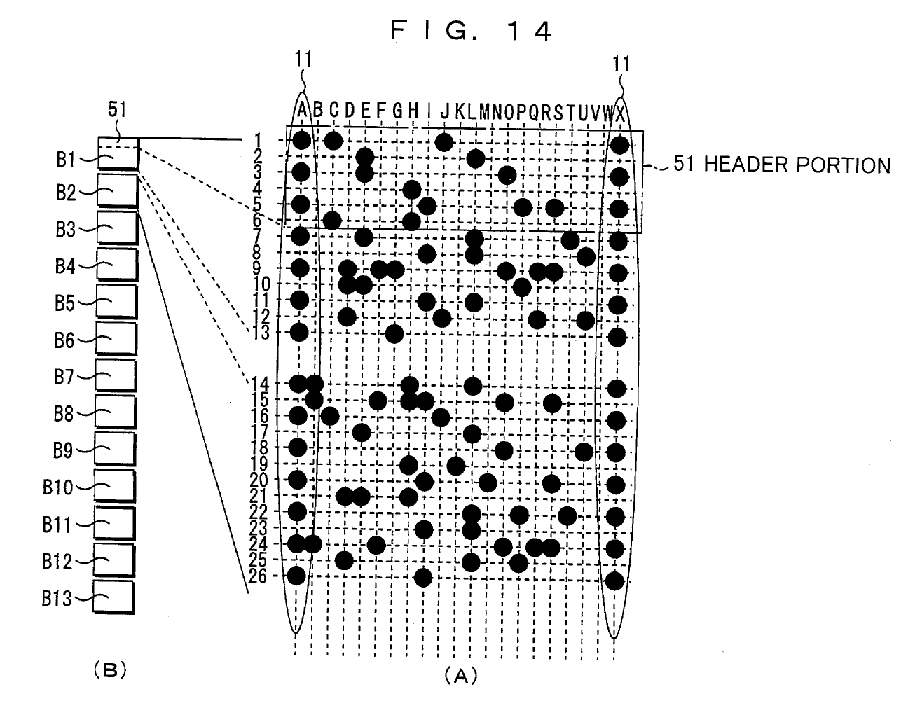

In the next place, the processing in the case that the code is read by the reader 21 will be explained below. On the occasion of this explanation, with reference to FIG. 6, the constitution of the reader 21 will be explained in advance. A reading head 31 of the reader 21 is controlled by a CPU (Central Processing Unit) 32. The reading head 31 reads the printed codes optically and outputs the image data of the read codes to the CPU 32. The CPU 32 recognizes the codes from the image data of the codes that are read by the reading head 31 as well as controls the reader 21 to store the recognition result in a HDD (Hard Disk Drive) 34 or output it to an outside device (not illustrated). Additionally, the CPU 32 recognizes the code among the image data of the codes that are inputted by the reading head 31 on the basis of the information such as the number of the nozzle 3 of the printer head 2 and the main scanning direction of the printer head 2 or the like, which are recorded in the header portion 51 (to be described later with reference to FIG. 14). In addition, the CPU 32 appropriately uses a memory 33 upon recognizing the images of the codes inputted by the reading head 31.

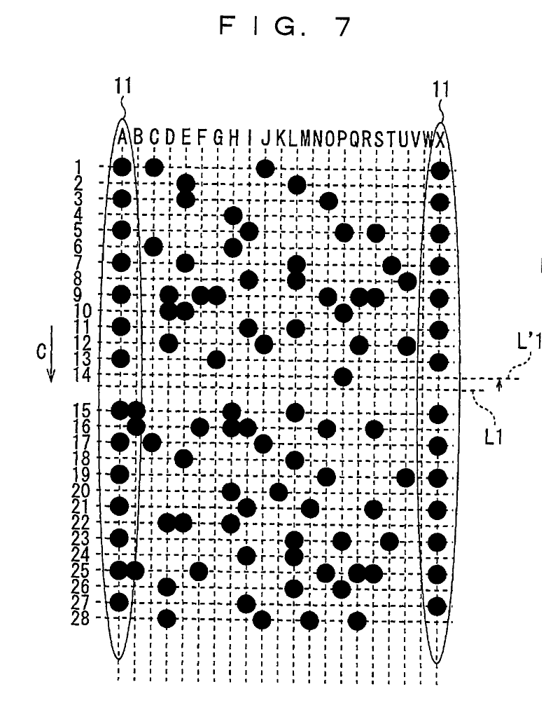

Upon recognizing the code, the reader 21 recognizes a position of each dot that is printed as a code from the image data of the code that is inputted by the reading head 31 as a latticed coordinate as shown in FIG. 7 to thereby decode the digital data depending on the absence or presence of a dot of this coordinate position (for example, a coordinate with a dot is represented as 1 and a coordinate without a dot is represented as 0).

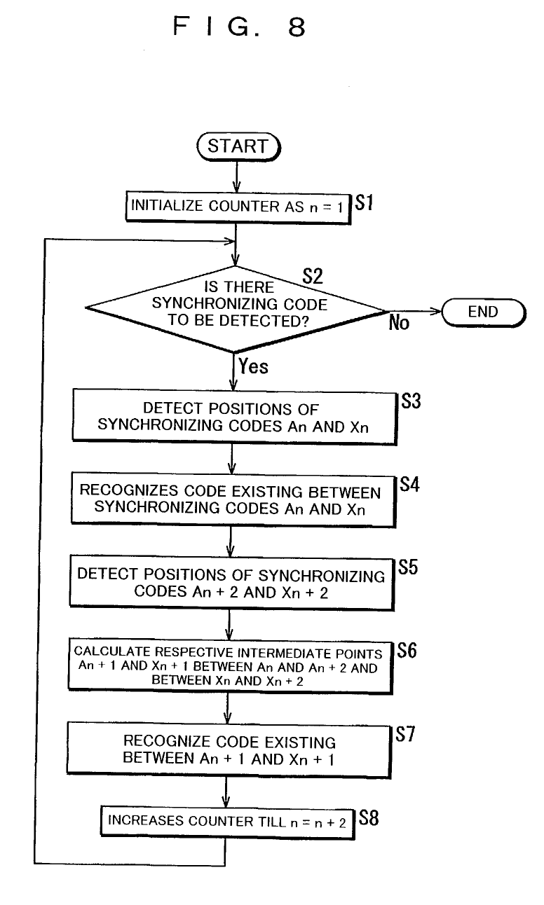

In the next place, with reference to a flow chart shown in FIG. 8, the processing in the case that the codes printed as shown in FIG. 7 are read by the reader 21 will be explained below. In the following explanation, a counter n counts a row number in a vertical direction of a dot that is printed as a code (i.e., an arrowhead direction C in FIG. 7). Alternatively, it is assumed that a row number in a horizontal direction of a code (i.e., a direction vertical with respect to the arrowhead direction C in FIG. 7) is represented as A to X as shown in FIG. 7. In addition, it is assumed that the codes are scanned sequentially in the arrowhead direction C in the drawing. Additionally, a lattice line shown in FIG. 7 is not printed in a real code but herein it is illustrated for convenience of the explanation of the reading processing by the reader 21.

In step S1, the CPU 32 initializes a counter of the memory 33 as n=1.

In step S2, the CPU 32 determines whether or not the synchronizing code column 11 to be detected is detected from the image data that is read by the reading head 31. In the case that the synchronizing code column 11 to be detected is not detected, this processing will be terminated and in the case that the synchronizing code column 11 to be detected is detected, this processing proceeds to step S3.

In the step S3, the CPU 32 detects the positions of the synchronizing codes An and Xn of the synchronizing code column 11 from the image data that is read by the reading head 31. In this case, a counter value is n=1, so that the positions of the synchronizing codes Al and Xl are detected. For example, the synchronizing code An means the synchronizing code of the dot at the Ath column and at nth row of the codes shown in FIG. 7. In the same way, the synchronizing code Xn means the synchronizing code of the dot at the Xth column and at nth row.

In step S4, the CPU 32 recognizes a code (a dot) existing between the synchronizing codes An and Xn from the image data that are read by the reading head 31 to store the recognition result in the memory 33. In this case, since the counter value is n=1, the dots existing between the synchronizing codes A1 and X1 are to be recognized, so that the dots existing between the codes C1 and J1 are read. For example, the data of the coordinates of positions corresponding to the codes C1 and J1 are recognized as 1 and the data of the coordinates at other positions are recognized as 0 and the recognition result is stored in the memory 33.

In step 5, the CPU 32 detects the positions of the synchronizing codes An+2 and Xn+2 from the image data that are read by the reader 31. In step S6, the CPU 32 calculates the positions of respective intermediate points An+1 and Xn+1 between the synchronizing codes An and An+2 and between the synchronizing codes Xn and Xn+2 on the basis of the positions of the detected synchronizing codes An+2 and Xn+2. In step S7, the CPU 32 recognizes a code existing between the intermediate points An+1 and Xn+1 from the images that are read by the reader 31. In other words, in this case, since the synchronizing code (dot) is printed for each row in the synchronizing code column 11, the codes for one row exist between respective synchronizing code rows. Therefore, the code between respective synchronizing code rows, namely, in this case, a code at a second row between a first row and a third row is read.

In step S8, the CPU 32 increases the counter value of the memory 33 till n=n+2 and its processing returns to the step S2. If it is determined that the processes from the step S3 to S8 are performed in all rows according to the processing of the step S2, the processing is terminated.

According to the processing of step S6, as the positions of respective intermediate points An+1 and Xn+1 between the synchronizing codes An and An+2 and between the synchronizing codes Xn and Xn+2, for example, a position of 14th row, namely, an intermediate position between the 13th row and 15th row shown in FIG. 7 (i.e., a position of an intermediate point between A14 and X14) is calculated as a position shown in L1. However, in fact, a dot is printed at a position on a line shown by L′1. This is why a portion, in which the codes are not printed for each main scanning of the printer head 2, is generated (namely, a blank row is formed) without using the nozzles 3a and 3b of the printer head 2 as shown in FIG. 5.

Accordingly, upon calculating the positions of the intermediate point, dynamic correction is required on the basis of a position of a dot of a code to be printed on a row between respective synchronizing code columns 11.

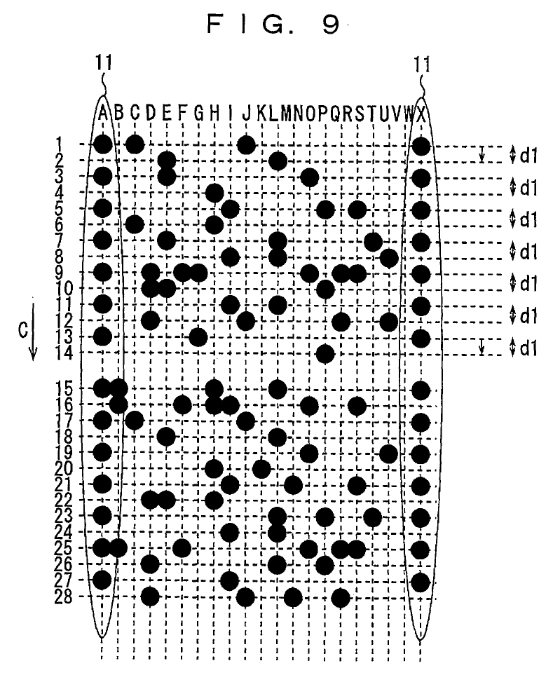

In this case, as described above, the correction of the position in the calculation at the step S6 is required at a border between the areas to be main-scanned by the printer head 2, namely, a portion that is scanned by the nozzles 3a and 3b that are not used for printing. Therefore, as shown in FIG. 9, obtaining an intermediate distance d1 (a half distance of the distance between the synchronizing codes A1 and A3 or a half distance of the distance between the synchronizing codes X1 and X3) between a first row and a third row to be certainly printed (i.e., rows to be printed by the nozzles 3c and 3e) and performing the processing as defining the positions always lower than the positions where the synchronizing codes An and Xn are detected by the intermediate distance d1 in the drawing as the positions of the intermediate points An+1 and Xn+1, it is possible to accurately recognize the codes even at the boundary of the areas to be scanned by the printer head 2. Accordingly, the processing in the step S6 shown in FIG. 8 can be carried out by adding the intermediate distance d1 that is obtained by the first processing to the positions where the synchronizing codes An and Xn are detected. In this case, the processing in the step S5 may be skipped after the processing for obtaining the intermediate distance d1 at the beginning is carried out.

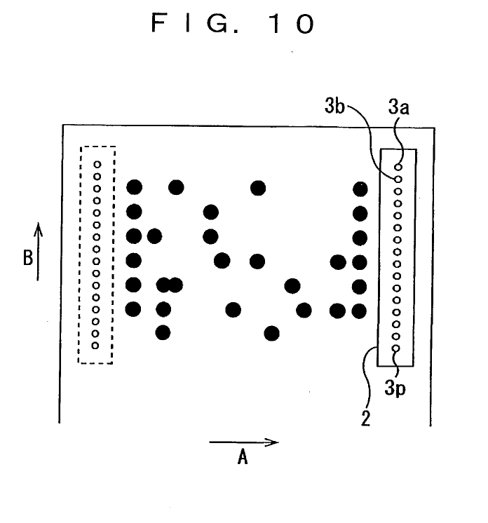

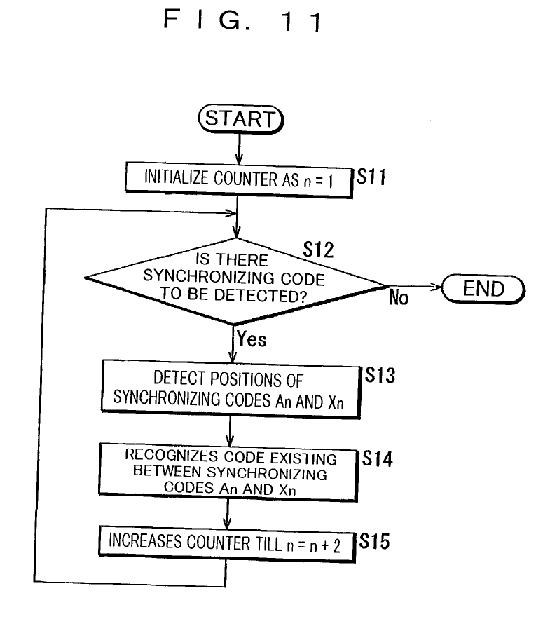

Although, according to the above description, as shown in FIG. 4, each synchronizing code (i.e., each dot) of the synchronizing code column 11 is printed for each one row or two rows in a sub scanning direction (i.e., the feeding direction of the print sheet 1 shown by the arrowhead direction B in the drawing), a dot of a code is printed for each row. However, in the case that the accuracy of the dot position is not good, as shown in FIG. 10, a dot of a code may be also printed for each one row or two rows. The code reading processing in this case will be explained with reference to a flow chart in FIG. 11.

In steps S11 to S14 and in step S15, the same processes as those in steps S1 to S4 and in step S8 in FIG. 8 are carried out. In other words, the processes in FIG. 8 are carried out as skipping the processes of steps S5 to S7.

According to an example shown in FIG. 4, since the codes for one row may exist between respective synchronizing codes of the synchronizing code column 11, it is necessary to recognize the codes existing therein by the processes in steps S5 to S7. However, there is no code between the rows of the synchronizing code in the case of an example shown in FIG. 10, so that there is no need to perform the processes of steps S5 to S7.

In this way, even in the case that a dot of a code is formed for each one row or two rows as same as the dot in the synchronizing code column 11, it is possible to apply the present invention.

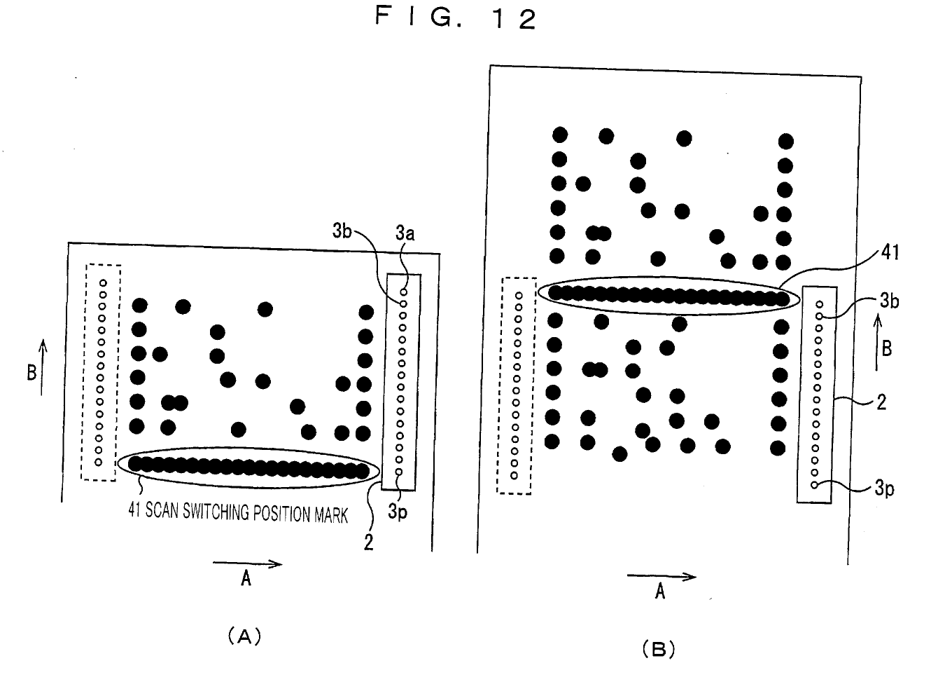

Alternatively, according to an example shown in FIG. 10, the nozzle 3p at the lowest stage is not used (namely, the synchronizing code column 11 or the dot of the code is not formed). Therefore, as shown in FIG. 12(A), using the nozzle 3a, it is possible to form the scan switching position mark 41. Hereby, a switching portion of scanning by the printer head 2 can be recognized. As a result, the printed codes can be recognized more accurately.

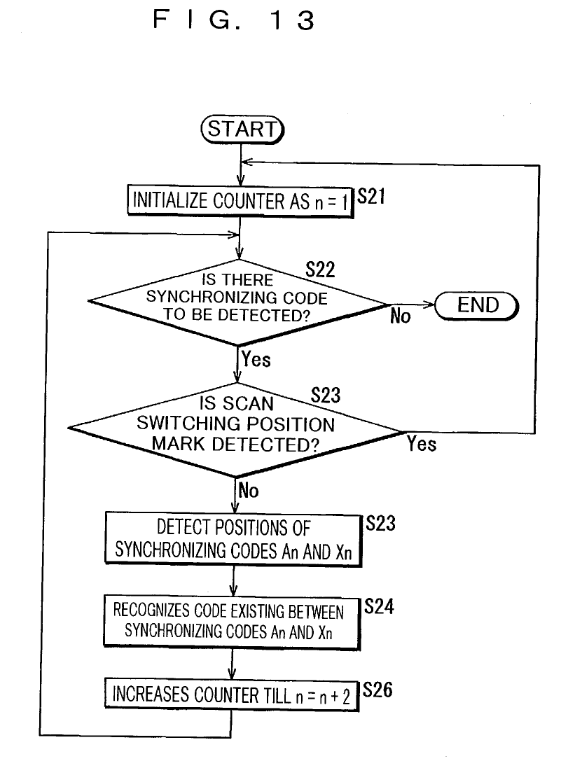

The code reading processing in this case will be explained with reference to a flow chart shown in FIG. 13.

In steps S21 and S22, the processes as same as those in steps S11 and S12 shown in FIG. 11 are carried out, so that the explanations thereof are herein omitted.

In step S23, the CPU 32 performs the process for detecting the scan switching position and simultaneously, determines whether or not the scan switching position mark 41 is detected. Then, if it is determined that the scan switching position mark 41 is detected, the processing proceeds to step S24. In steps S24 to S26, the processes as same as those in steps S13 to S15 shown in FIG. 11 are carried out, so that the explanations thereof are herein omitted.

If it is determined that the scan switching position mark 41 is detected in the step S23, the CPU 32 returns to step S21 and the processes after that will be carried out.

In the above cases, the value of the counter n is increased by two, so that a total number of the nozzles to print a code among the nozzles 3 of the printer head 2 is limited to an even number. For example, in FIG. 7, the number of the nozzles 3 that are used for printing is fourteen and the number of the nozzles that are not used are two. Therefore, it can be understood that the total number of the nozzles of the printer head 2 is sixteen.

Therefore, as shown in FIG. 14, providing the header portion 51 including the information with regard to the total number of the nozzles 3 of the printer head 2 in the codes, it is possible to record the information in the header portion 51. In this case, the CPU 32 changes a row for detecting the synchronizing code column 11 into an even row or an odd row alternately for each main scan of the printer head 2 on the basis of the information of the header portion 51, which is read by the reading head 31.

FIG. 14(A) shows the codes in the case that the header portion 51 is provided. A range from a first row to a sixth row of the codes composes the header portion 51. The CPU 32 recognizes the number of the nozzles 3 that printed the codes among the nozzles 3 of the printer head 2 on the basis of the information of the header portion 51 to recognize the codes by performing the process in association with this number.

In other words, for example, as shown in FIG. 14(A), in the case of a code that is printed by using the printer head 2 by the use of the thirteen (odd number) nozzles (if there are two nozzles that are not used, the total number of the nozzles becomes fifteen), as shown in FIG. 14(B), if the range including the header portion 5 to be printed by the first main scanning is defined as a first block B1, the synchronizing codes of the synchronizing code columns 11 are printed in the positions at the odd rows, namely, A1, A3, A5, A7, A9, A11, A13 and X1, X3, X5, X7, X9, X11 and X13 as shown in FIG. 14(A).

On the contrary, in a second block B2 to be printed by the next main scanning of the printer head 2, the synchronizing codes of the synchronizing code columns 11 are printed in the positions at the even rows, namely, A14, A16, A18, A20, A22, A24, A26 and X14, X16, X18, X20, X22, X24 and X26.

Therefore, assuming that an increment value of the counter n is defined as 1 (namely, a value of the counter n is increased as n=n +1) for each reading of the codes in the synchronizing code column 11 for the number of the nozzles on the basis of the information with regard to the number of the nozzles that is recorded in the header portion 51, it is also possible to read the codes that are printed by the printer head 2 having odd nozzles by interchanging the detecting positions (rows) of the synchronizing code column 11 into an even row and an odd row alternately.

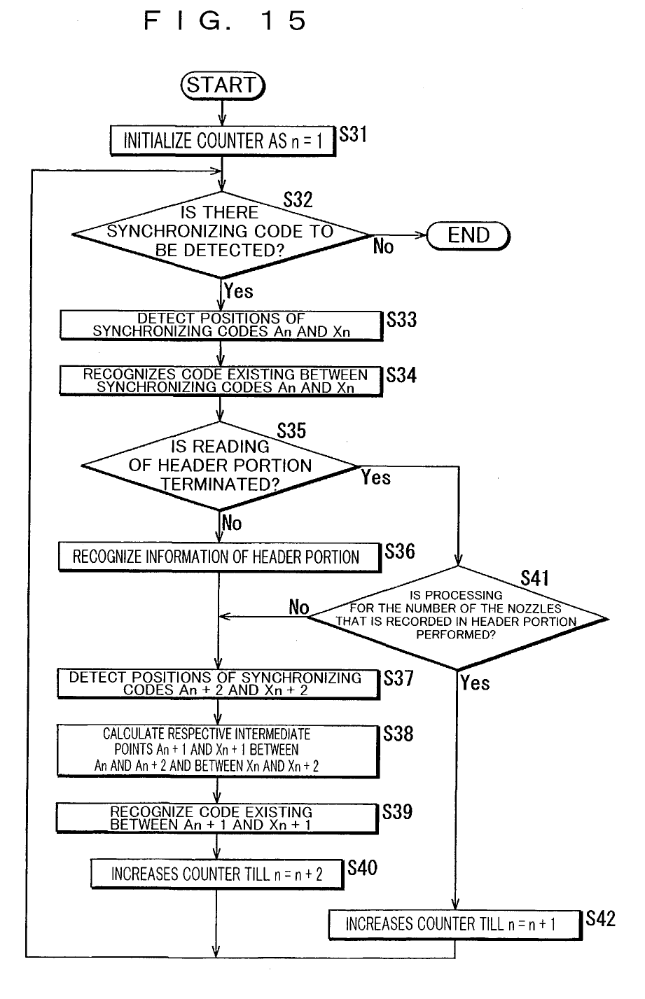

This processing will be explained with reference to a flow chart shown in FIG. 15.

In step S31, the CPU 32 initializes a counter as n=1. In step S32, the CPU 32 determines whether or not the synchronizing code column 11 to be detected is detected from the image data that is read by the reading head 31. In the case that the synchronizing code column 11 to be detected is not detected, this processing is terminated and in the case that the synchronizing code column 11 to be detected is detected, this processing will proceed to step S33.

In step S33, the CPU 32 detects the positions of the synchronizing codes An and Xn of the synchronizing code columns 11 from the image data that is read by the reading head 31. In this case, since a value of the counter is n=1, the positions of the synchronizing codes An and Xn are detected.

In step S34, the CPU 32 controls the reading head 31 and recognizes the codes existing between the recognized synchronizing codes An and Xn to thereby store the recognition result in the memory 33.

In step S35, the CPU 32 determines whether or not the reading by the header portion 51 is terminated. In this case, the CPU 32 determines whether or not the counter value is n<6. Then, if the case that the reading by the header portion 51 is not terminated (namely, in the case that the CPU 32 determines that the counter value is n<6), the CPU 32 assumes the codes that are recognized at the present moment comprise the information of the header portion 51 and the processing will proceed to step S36.

In step S36, the CPU 32 recognizes the codes of the header portion 51 and stores them in the memory 33. Then, the processing will proceed to step S37.

In step S37, the CPU 32 detects the positions of the synchronizing codes An+2 and Xn+2 of the synchronizing code columns 11 from the image data that is read by the reading head 31. In step S38, the CPU 32 calculates the positions of respective intermediate points An+1 and Xn+1 between the synchronizing codes An and An+2 and the synchronizing codes Xn and Xn+2 on the basis of the detected positions of the synchronizing codes An+2 and Xn+2. Additionally, according to the processes in steps S37 and S38, as explained in steps S5 and S6 in the flow chart shown in FIG. 8, the positions of the intermediate points An+1 and Xn+1 may be obtained by obtaining the intermediate distance d1 and adding it to the positions of the synchronizing codes An and Xn.

In step S39, the CPU 32 recognizes the codes existing between An+1 and Xn+1 from the image data that are read by the reading head 31. In step S40, the CPU 32 increase the counter value till n=n +2 and its processing returns to the step S2.

If it is determined that the reading by the header portion 51 is terminated in the step S35, namely, if the counter value n is determined that it is not n<6, its processing will proceed to step S41.

In step S41, making inquiries about the information of the header portion 51 that is stored in the memory 33, the CPU 32 determines whether or not the processing for one block, namely, the processing for the number of the nozzles 3 that is recorded in the printer head 2 is performed. If it is determined that the reading processing for the number of the nozzles 3 that is recorded (i.e., thirteen nozzles) has not been performed yet, its processing will proceed to step S37 and the processes after that will be repeated.

In the step S41, in the case that it is determined that the processing for one block, namely, the processing for the number of the nozzles 3 that is recorded in the printer head 2 is performed, namely, for example, in the case of the processing at the thirteenth row (n=13), its processing will proceed to step S42 and the CPU 32 returns to the processing in the step S32 with the counter value of the memory 33 as n=n+1. Then, the processes after that will be repeated. In other words, the counter is increased till n=14, so that in the processes after that, the processing for detecting the odd synchronizing code (i.e., the processing for reading the codes in the range of a second block B2) will be repeated. Then, returning to the step S41, in the case of the counter n=26 (the processing at the twenty-sixth row), namely, in the case that the processing for thirteen nozzles 3 is terminated, the counter is increased till n=27 (=26+1) and the odd synchronizing code will be detected.

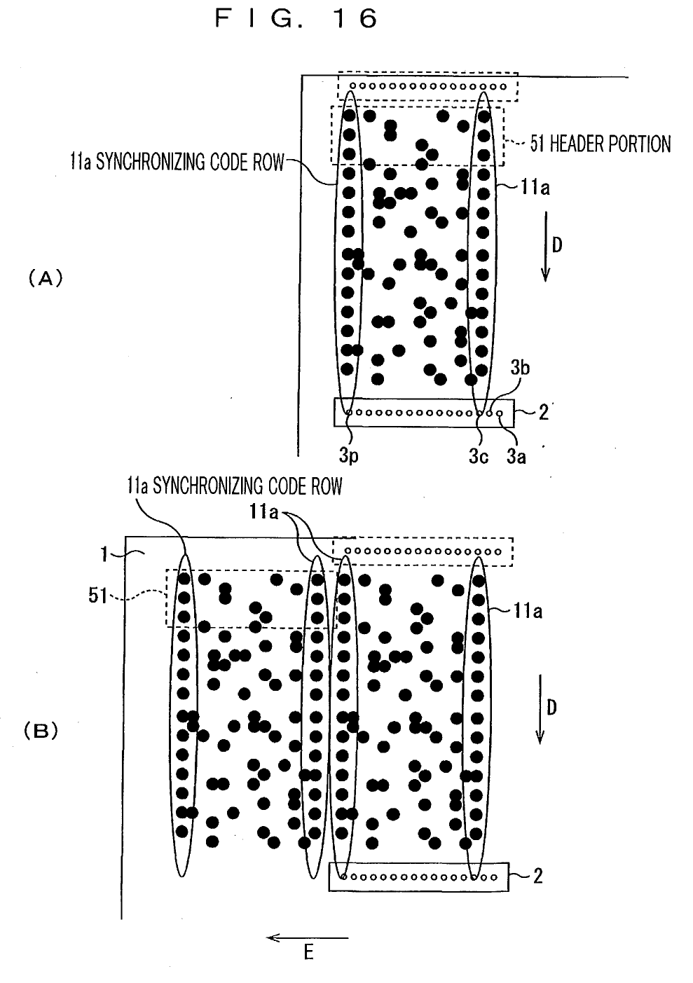

In the next place, FIG. 16(A) shows a printing example of the codes when the scanning direction of the printer head 2 is defined as a longitudinal direction (i.e., the arrowhead direction D in the drawing) of the print sheet 1. In this time, the synchronizing codes are printed in parallel with the main scanning direction, so that synchronizing code rows lla are formed. Additionally, the synchronizing code row 11a is the same as the synchronizing code column 11. Although the synchronizing code columns 11 are arranged in a column direction, the synchronizing codes rows 11a are arranged in a row direction. Alternatively, the header portion 51 also consists of the range from the first row to the sixth row of the first scan block of the codes in this example and it includes the information with respect to the total number of the nozzles 3 of the printer head 2.

In the above case, the total number of the nozzles 3 of the printer head 2 is sixteen, however, as same as the above described cases, the nozzles 3a and 3b are not printed. Therefore, as shown in FIG. 16(B), the codes are prevented from overlapping with the codes in the adjacent block.

The processing such that the reader 21 recognizes the codes shown in FIG. 16 is the same as the above described processing, so that its explanation is herein omitted.

In the above described examples, the header portion 51 consists of the range from the first row to the sixth row of the first scan block of the codes, however, the header portion 51 may be composed of other number of columns. Alternatively, in the above described examples, a case such that the information with regard to the total number of the nozzles 3 is included as the information of the header portion 51 is explained. However, the information with regard to the main scanning direction of the printer header 2 (i.e., the information that the main scanning direction is a longitudinal direction or a width direction with respect to the print sheet 1) is included, the reader 21 is capable of recognizing whether the codes are printed when the printer head 2 is main scanned in a longitudinal direction with respect to the print sheet 1 or they are printed when the printer head 2 is main scanned in a width direction with respect to the print sheet 1.

In addition, in the above described examples, a case such that two nozzles at one end in the nozzles 3 of the printer head 2 are not used for printing has been explained. However, if the codes to be printed by the nozzle at the end of the printer head 2 do not overlap with the code in the adjacent block, one nozzle or three or more nozzles may be available. In addition, the nozzles at the opposite ends of the printer head 2 may not be used for printing.

As described above, it is prevented that the codes are printed as overlapping with each other and the printed codes are read at the accurate positions to thereby permit accurate recognition of the printed codes.

As being obvious from the above explanations, according to the code printing method and the code format of the present invention, the accurate recognition of the printed code becomes possible.

What is claimed is:

1. A code printing method of a printer by the use of a printer head in which a plurality of nozzles is lined in a row; comprising the steps of:
scanning said printer head; and
printing a code on a print sheet by a predetermined nozzle among said plural nozzles at a predetermined scanning position in said printer head that was scanned according to the processing of said scanning step;
wherein, according to the processing in said printing step, a predetermined nozzle is only used for printing except for the nozzle at one end of said printer head or at least not less than one nozzle at the opposite ends of said printer head among said plural nozzles.

2. A code printing method of a printer by the use of a printer head in which a plurality of nozzles is lined in a row; comprising the steps of:
scanning said printer head; and
printing a code on a print sheet by a predetermined nozzle among said plural nozzles at a predetermined scanning position in said printer head that was scanned according to the processing of said scanning step;
wherein, according to the processing in said printing step, a predetermined nozzle among said plural nozzles is only used for printing codes except for at least not less than one nozzle at the opposite ends of said printer head and the nozzle at one end of said printer head among said plural nozzles is used for printing a mark showing a scan switching position in said scanning step.

3. A code printing method of a printer by the use of a printer head in which a plurality of nozzles is lined in a row; comprising the steps of:
scanning said printer head; and
printing a code on a print sheet by a predetermined nozzle among said plural nozzles at a predetermined scanning position in said printer head that was scanned according to the processing of said scanning step;
wherein, according to the processing in said printing step, synchronizing codes are printed at a first column and a last column of said code or a first row and a last row of said code according to the processing in said scanning step.

4. A code format to be printed by a printer by the use of a printer head in which a plurality of nozzles is lined in a row; comprising a mark showing a scan switching position for each range to be printed by single scanning of said printer head.

5. A code format to be printed by a printer by the use of a printer head in which a plurality of nozzles is lined in a row; including a header portion having the information with respect to any one of the number of the nozzles of said printer head and a scanning direction of said printer head or the information with respect to both of them.

6. A code format to be printed by a printer by the use of a printer head in which a plurality of nozzles is lined in a row; including a synchronizing code in a vertical direction or a parallel direction against a feeding direction of a print sheet for each range to be printed by single scanning of said printer head.

7. A code printing method according to claim 1,
wherein, according to the processing in said printing step, synchronizing codes are further printed at a first column and a last column of said code or a first row and a last row of said code according to the processing in said scanning step.

8. A code printing method according to claim 7,
wherein, according to the processing in said printing step, the information with respect to at least one of the number of the nozzles of said printer head and a scanning direction of said printer head or the information with respect to both of them is further printed.

9. A code printing method according to claim 1,
wherein, according to the processing in said printing step, the information with respect to at least one of the number of the nozzles of said printer head and a scanning direction of said printer head or the information with respect to the both of them is further printed.

10. A code format according to claim 5; including a synchronizing code in a vertical direction or a parallel direction against a feeding direction of a print sheet for each range to be printed by single scanning of said printer head.
